(19) United States
(12) Patent Application Publication
(10) Pub. No.: US 2001/0046089 A1
(43) Pub. Date: Nov. 29, 2001

(54) Spatial filter source beam conditioning in ellipsometer and the like systems

(76) Inventors: Martin M. Liphardt, Lincoln, NE (US); Blaine D. Johs, Lincoln, NE (US); Craig M. Herzinger, Lincoln, NE (US); Ping He, Lincoln, NE (US)

Correspondence Address: JAMES D. WELCH, 10328 PINEHURST AVE., OMAHA, NE, 68124, US

(21) Appl. No.: 09/854,548

(22) Filed: May 14, 2001

Related U.S. Application Data
(60) Provisional application No. 60/207,537, filed on May 26, 2000.

(51) Int. Cl. G02B 27/10; G02B 27/30

(52) U.S. Cl. 359/618; 359/641

(57) ABSTRACT

Disclosed is the application of spatial filter(s) in ellipsometer and the like systems prior to a sample system. The purpose is to eliminate a radially outer annulus of a generally arbitrary intensity profile, so that electromagnetic beam intensity is caused to quickly decay to zero, rather than, for instance, demonstrate an irregular profile as a function of radius.

This Application is a CIP of Ser. No. 60/207,537 filed May 26, 2000.

### TECHNICAL FIELD

The present invention relates to systems and methods for processing electromagnetic beams and more particularly to application of spatial filter(s) in ellipsometer and the like systems prior to investigated sample systems, which spatial filter(s) serve to eliminate a radially outer annulus in which intensity is comprised of undesirable irregular low intensity level content.

### BACKGROUND

Not limited to, but particularly in the case where an electromagnetic beam is utilized to investigate a sample system which presents with a varying depth surface topology, it is important to provide an electromagnetic beam of a known lateral dimension and which presents with a relatively simple cross-sectional Intensity profile.

It is noted that often electromagnetic beams present with a substantially arbitrary intensity profile, with the highest intensity generally being located centrally, and with intensity decreasing with increasing radius. While such a beam intensity profile is typically acceptable for use in ellipsometry and related practices, it has been found that once the intensity of a substantially arbitrary profile beam of electromagnetic radiation has dropped to, as an arbitrary example, say ten (10%) of its maximum, that said intensity in many beams does not always continue to decay directly to essentially zero (0.0). Instead, it often presents irregularly as a function of radius, (eg. easily visualized as being generally similar to the Fourier transform of a square wave). The cause of said irregular intensity profile can include such as optical element wavelength dependent diffraction, surface roughness or other non-idealities, and where, for instance, electromagnetic radiation is provided via an aperture or via the end of a light fiber contained in a cladding, such that electromagnetic radiation falls outside a geometric image thereof.

It would be of benefit, as regards obtaining accurate data from application of ellipsometers and the like systems, if the intensity of an electromagnetic beam could be forced to decay quickly to zero (0.0), rather than demonstrate an irregular intensity profile as a function of radius.

With an eye to the present invention, a Search of Patents was conducted. Perhaps the most relevant Patent identified is U.S. Pat. No. 5,517,312 to Finarov. Said 312 patent describes application of a scattered light reducing system at the entry to a Detector of an Ellipsometer or Spectrophotometer System, which scattered light reducing system consists of two lenses with a pin-hole containing diaphram located midway therebetween, and at the focal lengths of said lenses. Said scattered light reducing system is present after a sample system and processes electromagnetic radiation after it interacts with said sample system. The pinhole is described as serving to provide high spatial resolution as well as reduce scattered light. Another Patent identified is that to Campbell et al., U.S. Pat. No. 5,148,323. Said 323 patent describes a Spatial Filter in which a pinhole is located other than at the focal length of a converging lens. U.S. Pat. No. 3,905,675 to McCraken describes a Spatial Filter containing system which enables observation of a weak source of electromagnetic radiation in the presence of strong sources thereof. U.S. Pat. No. 5,684,642 to Zumoto et al., describes an optical transmission system for use in fashioning an electromagnetic beam for use in machining materials which combines a Spatial Filter and an Optical Fiber. U.S. Pat. No. 4,877,960 is identified as it describes masking energy from outside the target area in a microscope having dual remote image masking.

Even in view of the known art, especially in the context of ellipsometer and spectrophotometer systems, a need exists for a means to fashion a beam with a radially arbitrary intensity profile that does not quickly decay to zero, into a beam in which the intensity relatively directly radially approaches zero intensity.

### DISCLOSURE OF THE INVENTION

The present invention comprises at least one Spatial Filter in the context of a system selected from the group:

reflectometer;

spectrophotometer;

ellipsometer;

spectroscopic ellipsometer;

polarimeter; and

spectroscopic polarimeter;

and the like;

which system alone, or in combination with additional elements, generates an electromagnetic beam and causes it to impinge upon a sample system via said at least one spatial filter;

which at least one spatial filter serves to attenuate an outer annular region from said electromagnetic beam as it passes therethrough.

Spatial filters minimally sequentially comprise:

beam converging at least one lens and/or mirror;

diaphram with a pin hole therein located near the focal length of said beam converging at least one lens and/or mirror; and

beam collimating at least one lens and/or mirror;

such that in use an electromagnetic beam which is caused to interact with said beam converging at least one lens and/or mirror becomes focused on, and at least partially passes through said pin hole in said diaphram, and then becomes recollimated by said second beam at least one collimating lens and/or mirror. It should be appreciated, of course, that the beam converging or collimating at least one lens and/or mirror can comprise a system of a plurality of lenses and/or mirrors.

A preferred present invention system comprises addition of an aperture such that the configuration becomes:

first beam collimating lens;

aperture;

first beam converging at least one lens and/or mirror;

diaphram with a pin hole therein located essentially at the focal length of said beam converging at least one lens and/or mirror; and

second beam collimating at least one lens and/or mirror;

and such that, in use, the central portion of the electromagnetic beam which is collimated by said first beam collimating lens is caused to pass through said aperture, become focused on and at least partially pass through said pin hole in said diaphram by said first beam converging at least one lens and/or mirror, and become recollimated by said second beam collimating at least one lens and/or mirror.

The present invention can also be considered to be a system which comprises:

polarization state generator which functionally includes said spatial filter;

means for supporting a sample system; and

polarization state detector;

wherein the spatial filter sequentially comprises:

first at least one lens and/or mirror;

pin hole containing diaphram; and

second at least one lens and/or mirror;

and wherein electromagnetic radiation preferably enters said spatial filiter via a collimating lens and aperture;

said pin hole containing diaphram being positioned near the focal points of said first and second at least one lenses and/or mirrors, such that a collimated electromagnetic beam enters said first at least one lens and/or mirror, is converged and at least partially passes through said pin hole, and is recollimated by said second at least one lens and/or mirror.

As insight to why the present invention pre-sample system positioned spatial filter works, it can be considered that the pin hole in the diaphram acts as an aperture at the location of an image of the end of a fiber optic, or source aperture, or other point source of a beam.

The present invention is further a method of processing electromagnetic beams to eliminate a radially outer annulus which is often comprised of low intensity level irregular content, said method comprising placing at least one spatial filter(s) such that said electromagnetic beam passes therethrough, each present spatial filter sequentially comprising:

beam converging at least one lens and/or mirror;

diaphram with a pin hole therein located near the focal length of said beam converging at least one lens and/or mirror; and

beam collimating at least one lens and/or mirror;

wherein electromagnetic radiation enters said spatial filter via an aperture;

such that, in use, an electromagnetic beam which is caused to pass through said aperture, becomes substantially focused on, and at least partially pass through said pin hole in said diaphram by said beam converging at least one lens and/or mirror, and then become recollimated by said second beam collimating at least one lens and/or mirror.

Said present invention method can be recited as, in the context of a selection from the group:

reflectometer;

spectrophotometer;

ellipsometer;

spectroscopic ellipsometer;

polarimeter;

spectroscopic polarimeter; and

and the like;

which alone or in combination with other elements causes a beam of electromagnetic radiation to interact with a sample system, comprising the steps of:

a. providing a beam of electromagnetic radiation;

b. providing a sample system;

c. placing at least one spatial filter(s) in the pathway of said electromagnetic beam such that said electromagnetic beam passes therethrough prior to said electromagnetic beam being caused to interact with a sample system;

the purpose being to eliminate a radially outer annulus of said electromagnetic beam which is comprised of a low intensity level irregular content.

In very general terms the present invention is a system which generates an electromagnetic beam and causes it to impinge upon a sample system, said system comprising, prior to said sample system, at least one spatial filter which serves to attenuate an outer annular region from said electromagnetic beam as it passes therethrough.

The present invention will be better understood by reference to the Detailed Description Section of this Specification, in conjunction with the Drawings.

### SUMMARY OF THE INVENTION

It is a purpose and/or objective of the present invention to teach positioning, prior to an investigated sample system, of a system for forming a beam of electromagnetic radiation which presents with an intensity profile which drops off radially quickly to 0.0, in reflectometer, ellipsometer, spectroscopic ellipsometer, polarimeter, spectroscopic polarimeter, spectrophotometer and the like systems.

It is a specific purpose and/or objective of the present invention to teach positioning, prior to an investigated sample system, of a spatial filter for forming a beam of electromagnetic radiation which presents with an intensity profile which drops off radially quickly to 0.0, in reflectometer, ellipsometer, spectroscopic ellipsometer, polarimeter, spectroscopic polarimeter, spectrophotometer and the like systems.

It is a specific purpose and/or objective of the present invention to teach a method for forming a beam of electromagnetic radiation which presents with an intensity profile which drops off radially quickly to 0.0, in reflectometer, ellipsometer, spectroscopic ellipsometer, polarimeter, spectroscopic polarimeter, spectrophotometer and the like systems.

Other purposes and/or objectives of the present invention will become apparent by a reading of the Specification and claims.

### BRIEF DESCRIPTION OF THE DRAWINGS

FIG. 1a1 shows a basic Reflectometer or Spectrophotometer comprising a Source of Electromagnetic Radiation and a Detector.

FIGS. 1a2, and 1a3 show demonstrative Ellipsometer systems in which the present invention spatial filter system is shown positioned prior to a sample system.

FIG. 2 shows an example of a source of electromagnetic radiation comprising a light fiber, lens apertures and polarizer.

FIG. 3a shows an example of a present invention spatial filter in combination with the system of FIG. 2.

FIG. 3b shows alternative spatial filter construction which can be applied in the context of a FIG. 2 system.

FIG. 4 shows the effect of the presence of a spatial filter on the radial intensity of an electromagnetic beam as is developed and utilized in ellipsometer, reflectometer and spectrophotometer etc. systems.

### DETAILED DESCRIPTION

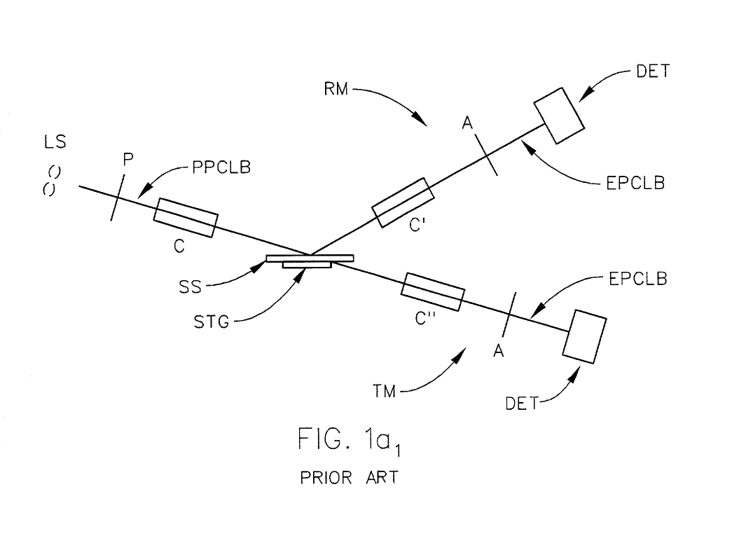

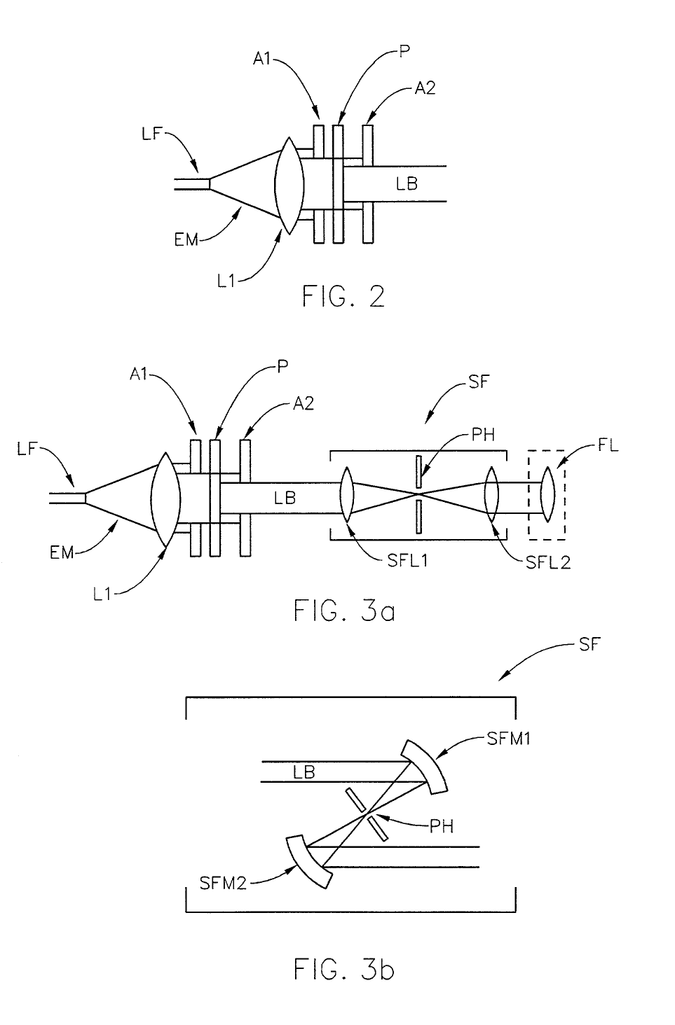

Turning now to the Drawings, there is shown in FIG. 1a1 a basic Reflectometer or Spectrophotometer comprising a Source of Electromagnetic Radiation and a Detector. A beam of electromagnetic radiation is shown reflecting from a Sample System (SS). Also shown is a present invention application of a Spatial Filter (SF), said Spatial Filter (SF) being shown and better presented and described with respect to FIGS. 3a and 3b.

FIG. 1a2 shows a general elemental configuration of an ellipsometer system to which the present invention can be applied to investigate a material system (SS). Shown for reflection and transmission are:

a. a Source of a beam electromagnetic radiation (LS);

b. a Polarizer element (P);

c. optionally a compensator element (C1);

d. optional additional element(s) (AC1);

e. a sample system (SS);

f. optional additional element(s) (AC2);

g. optionally a compensator element (C2);

h. an Analyzer element (A); and

i. a Detector System (DET).

The elements identified as (LS), (P) and (C1) can be considered to form, as a group, a Polarization State Generator (PSG), and the components (C2), (A) and (DET) can be considered, as a group, to form a Polarization State Detector (PSD). It is to be understood that the d. and f. optional “additional elements”, (AC1) and (AC2), can be considered as being, for instance, optional input and output lenses or perhaps windows in a vacuum chamber.

Also note that after the Polarizer (P) there is indicated, in dashed lines, the presence of a present invention Spatial Filter (SF). While other pre-sample system locations, (eg. prior to the Polarizer (P), after the Compensator (C1) or after the Additional Elements (AC1), are included in the scope of the invention, the shown location is preferred.

Another embodiment of an ellipsometer system to which the present invention can be applied is shown in FIG. 1a3, which shows a Perspective view of a demonstrative system. FIG. 1a3 shows a Light Source (LS) and a Polarizer (P), which in combination serve to produce a generally horizontally oriented Polarized Beam of Electromagnetic Radiation (LBI). Said generally horizontally oriented Polarized Beam of Electromagnetic Radiation (LBI) is caused to interact with Optical Element, (eg. Prism), (PRI), essentially totally internally reflect therein, pass through Focusing Optic (F1) and become generally vertically oriented Polarized Beam of Electromagnetic Radiation (LBI′), then interact with a Sample System (SS), which can be any Material System (MS), present on a Material System supporting Stage (STG). FIG. 1a3 shows that said interaction with the Surface of said Sample System (SS) causes a generally vertically oriented Polarized Beam of Electromagnetic Radiation (LBO′) to pass through Focusing Optic (F2). FIG. 1a3 also shows that after passing through Focusing Optic (F2) said generally vertically oriented Polarized Beam of Electromagnetic Radiation (LBO′) interacts with Optical Element, (eg. Prism), (PRO) and is essentially totally internally reflected thereby to become generally horizontally oriented Polarized Beam of Electromagnetic Radiation (LBO), which generally horizontally oriented Polarized Beam of Electromagnetic Radiation (LBO) passes through Analyzer (A) and then enters Detector System (DET), preferrably via Circular Aperture (AP), for analysis. It is noted that the purpose of the Focusing Optics (F1) is to produce a very Concentrated High Intensity Small Area Polarized Beam of Electromagnetic Radiation (LBI′) from Collimated Polarized Beam of Electromagnetic Radiation (LBI). The purpose of Focusing Optic (F2) is to “Re-Collimate” the generally vertically oriented Polarized Beam of Electromagnetic Radiation (LBO′) which results from the Focused Polarized Beam of Electromagnetic Radiation (LBI′) being Reflected from said Sample System (SS). The Re-Collimated generally vertically oriented Beam of Electromagnetic Radiation (LBI′) being identified as generally horizontally oriented Beam of Electromagnetic Radiation (LBO) after it has been caused to interact with Prism (PRO).

Also, as in the FIG. 1a2 case, note that shown after the Polarizer (P) there is indicated, in dashed lines, the presence of a present invention Spatial Filter (SF). Shown are a diaphram which contains a Pin Hole (PH), (which electromagnetic beam (LB1) passes through), which Pin Hole (PH) is located at essentially a Focal Length distant from each of Lenses (SFL1) and (SFL2). Again, while other pre-sample system locations are included in the scope of the invention, the shown location is preferred. Note that either of said Lenses (SFL1) and (SFL2) can be replaced with a functionally essentially equivalent mirror.

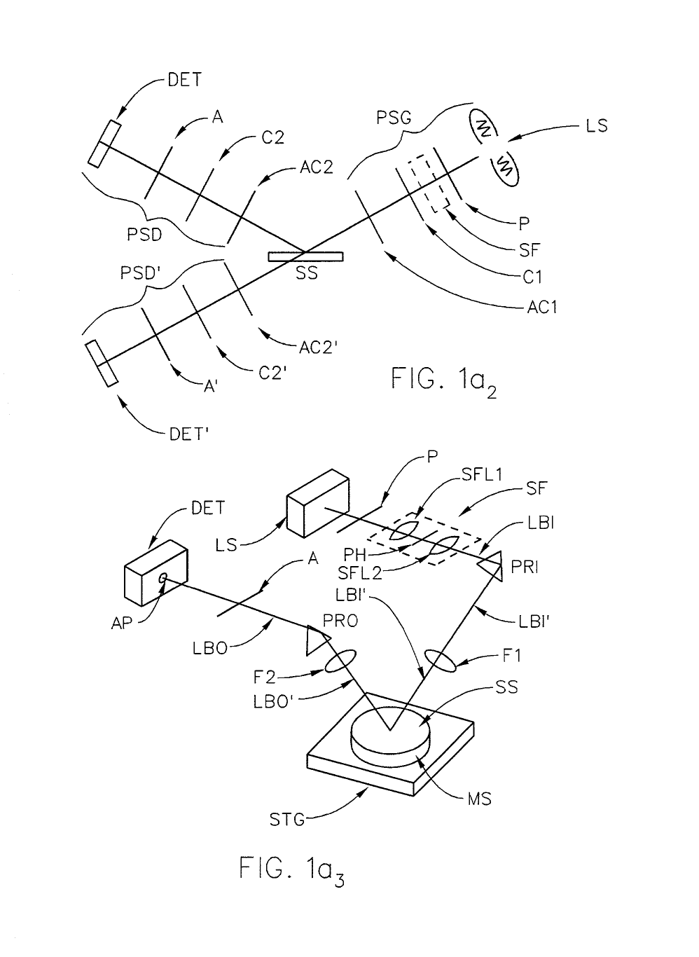

FIG. 2 shows that a Light Source (LS) can comprise a Light Fiber, a Lens (L1), and a First Aperture (A1). In the context of an ellipsometer a Polarizer (P) is also shown as it would be positioned. Shown in addition is a second Aperture (A2). In use electromagnetic radiation (EM) exiting the Light Fiber (LF) expands and enters Lens (L1) and is collimated thereby. First Aperture (A1) limits the beam diameter, and Second Aperture (A2) further does so to provide a beam of electromagnetic radiation labeled (LB).

FIG. 3a expands on FIG. 2 and shows a present invention spatial filter configuration. The Spatial Filter (SF) is placed so as to intercept the beam of electromagnetic radiation labeled (LB), and is converged by Lens or mirror (SFL1) such that it at least partially passes through a pin hole (PH) in a pin hole containing diaphram, (the diameter of which pin hole (PH) is typically about half that of the Light Fiber (LF) and corresponds to the Image diameter of the Light Fiber (LF) at the location of said Pin Hole (PH)), and then is re-collimated by Lens or mirror (SFL2). Note that The Pin Hole (PH) diameter, however, is not critical and can be bigger, and definitely smaller than just indicated. Also, the Pin Hole (PH) is generally located a Focal Length distant from each of the Lenses (SFL1) and (SFL2). Again it is to be understood that either of the Lenses (SFL1) and (SFL2) can be replaced by an essentially functionally equivalent mirror.

FIG. 3a also shows, (contained within dashed lines), that a Focusing Lens (FL) can also be present, and when present is functionally much like the Lens labeled (F1) in FIG. 1a3.

FIG. 3b shows alternative present invention Spatial Filter (SF) construction in which mirrors (SFM1) and (SFM2) perform the function of lenses (SFL1) and (SFL2) in FIG. 3a. That is the Spatial Filter shown in FIG. 3a can be replaced with that in FIG. 3b and remain within the scope of the present invention. It is further noted that a present invention Spatial Filter could comprise one Lens and one Mirror, in either order in a Spatial Filter, hence the language “lens or mirror” is to be interpreted broadly as meaning that each is independently selected from the group consisting of a lens and a mirror.

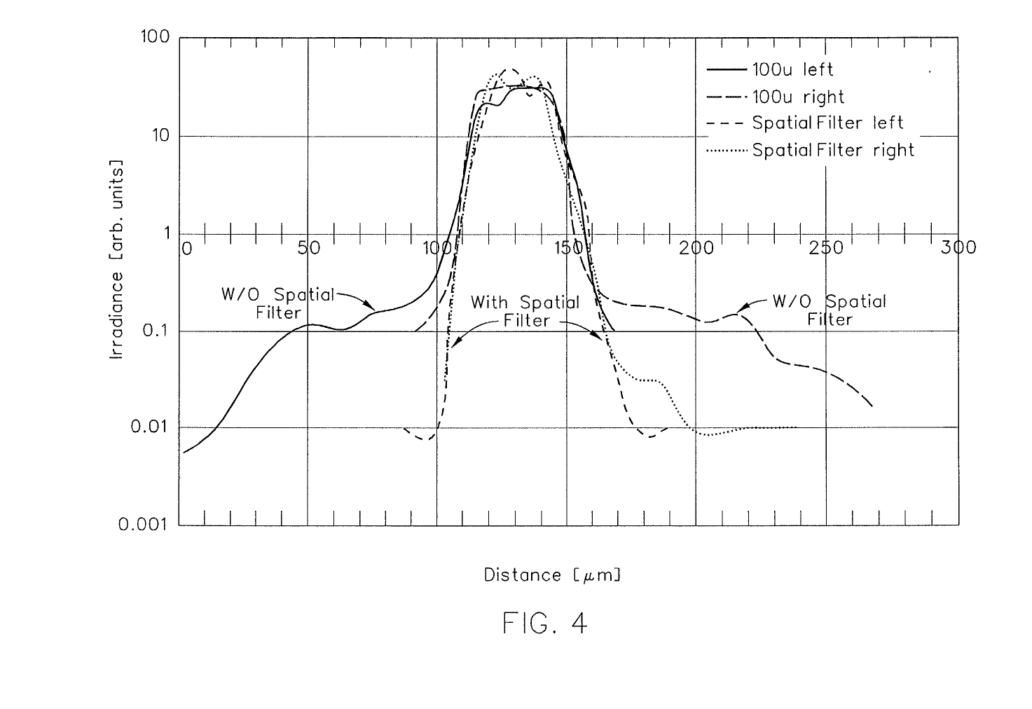

FIG. 4 shows the effect of the presence of the Spatial Filter (SF) as shown in FIG. 3a on the Intensity Profile of a beam of electromagnetic radiation passed therethrough. Note that FIG. 4 plots Intensity on a Log Axis, and that the Intensity drops toward 0.001 much quicker when the Spatial Filter (SF) is in place than when it is not in place.

The present invention also includes, in the context of a reflectometer, a spectrophotometer, an ellipsometer, a spectroscopic ellipsometer, a polarimeter, a spectroscopic polarimeter, and a spectrophotometer and the like systems, the Method of removing an radial outer annular ring from an electromagnetic beam by application of a spatial filter prior to a Sample Ssytem. Said method can be recited as a method of processing source electromagnetic beams to eliminate a radially outer annulus thereof, said radial outer annulus often being comprised of low intensity level irregular content, said method comprising placing at least one spatial filter(s) such that said electromagnetic beam passes therethrough.

The terminology “outer annular region” as used herein is to be interpreted to mean an outer region of an electromagnetic beam, as distinct from a central region thereof, which outer region appears as an annulus when it is considered that the intensity of the beam decreases to zero as the radius increases to infinity. Said “outer annular region” can be considered to begin at the point where the intensity of an electromagnetic beam falls to where intensity becomes irregular rather than continues directly to zero. This often occurs at below approximately ten (10%) percent of maximum intensity, and it is noted, can contain approximately two (2%) to five (5%) of the electromagnetic beam's energy content.

It is also noted that the language “at least partially pass through” as regards an electromagnetic beam interaction with a pin hole (PH) in a diaphram, indicates that at least part of an electromagetnic beam, typcally the central-most part, passes therethrough, with an annular region being blocked passage.

Finally, while technically a spatial filter (SF) is generally considered to consist of a converging lens or mirror, (or system of lens(es) and/or mirror(s)), an aperture and a collimating lens or mirror, (or system of lens(es) and/or mirror(s)), for the purposes of claim drafting it is to be understood that a spatial filter can be considered to further comprise such as a leading collimating lens and an aperture.

Having hereby disclosed the subject matter of the present invention, it should be obvious that many modifications, substitutions, and variations of the present invention are possible in view of the teachings. It is therefore to be understood that the invention may be practiced other than as specifically described, and should be limited in its breadth and scope only by the claims.

We claim:

1. A system which generates an electromagnetic beam and causes it to impinge upon a sample system, said system comprising, prior to said sample system, at least one spatial filter which serves to attenuate an outer annular region from said electromagnetic beam as it passes therethrough.

2. A system as in claim 1 in which said spatial filter sequentially comprises:
first beam collimating lens;
aperture;
beam converging at least one lens and/or mirror;
diaphram with a pin hole therein located essentially at the focal length of said at least one beam converging lens and/or mirror; and
second beam collimating at least one lens and/or mirror;
such that in use the central portion of the electromagnetic beam which is collimated by said first beam collimating lens is caused to pass through said aperture, become focused on and at least partially pass through said pin hole in said diaphram by said beam converging at least one lens and/or mirror, and become recollimated by said second beam collimating at least one lens and/or mirror.

3. A system as in claim 1 wherein the system is selected from the group consisting of:
reflectometer;
spectrophotometer;
ellipsometer;
spectroscopic ellipsometer;
polarimeter; and
spectroscopic polarimeter;
and comprises a source of electromagnetic radiation in functional combination with said spatial filter which sequentially comprises:
beam converging at least one lens and/or mirror;
diaphram with a pin hole therein located essentially at the focal length of said beam converging at least one lens and/or mirror; and
beam collimating at least one lens and/or mirror;
such that in use the electromagnetic beam is caused to become focused on and at least partially pass through said pin hole in said diaphram by said beam converging at least one lens and/or mirror, and then become recollimated by said beam collimating at least one lens and/or mirror.

4. A system as in claim 1, in which the system comprises:
polarization state generator which functionally includes said spatial filter;
means for supporting a sample system; and
polarization state detector.

5. A system as in claim 1, in which the spatial filter sequentially comprises:
aperture;
first at least one lens and/or mirror;
pin hole containing diaphram; and
second at least one lens and/or mirror;
said pin hole containing diaphram being positioned at the focal points of said first and second lenses or mirrors, such that a collimated electromagnetic beam enters said first at least one lens and/or mirror, is converged and at least partially passes through said pin hole, and is re-collimated by said second at least one lens and/or mirror.

6. A system as in claim 1 which comprises:
a. a Source of a beam electromagnetic radiation (LS);
b. a Polarizer element (P);
c. optionally a compensator element (C1);
d. optional additional element(s) (AC1);
e. a material system (SS);
f. optioanl additional element(s) (AC2);
g. optionally a compensator element (C2);
h. an Analyzer element (A); and
i. a Detector System (DET);
wherein said spatial filter is present after said polarizer but before said material system, and comprises:
optional aperture;
beam converging at least one lens and/or mirror;
diaphram with a pin hole therein located essentially at the focal length of said beam converging at least one lens and/or mirror; and
beam collimating at least one lens and/or mirror.

7. A method of processing electromagnetic beams to eliminate a radially outer annulus thereof, said method comprising placing at least one spatial filter(s) such that said electromagnetic beam passes therethrough, said spatial filter sequentially comprising:
aperture;
beam converging at least one lens and/or mirror;
diaphram with a pin hole therein located essentially at the focal length of said beam converging at least one lens and/or mirror; and
beam collimating at least one lens and/or mirror;
such that in use an electromagnetic beam which is caused to pass through said aperture, become focused on and at least partially pass through said pin hole in said diaphram by said beam converging at least one lens and/or mirror, and become recollimated by said second beam collimating at least one lens and/or mirror.

8. A method of investigating a sample system, in the context of a selection from the group consisting of:
reflectometer;
spectrophotometer;
ellipsometer;
spectroscopic ellipsometer;
polarimeter; and
spectroscopic polarimeter;
which causes a beam of electromagnetic radiation to interact with a sample system;
comrprising the steps of:
a. providing a beam of electromagnetic radiation;
b. providing a sample system;
c. placing at least one spatial filter(s) in the pathway of said electromagnetic beam such that said electromagnetic beam at least partially passes therethrough prior to said electromagnetic beam being caused to interact with said sample system;
the purpose being to eliminate a radially outer annulus of said electromagnetic beam which is comprised of a low intensity level irregular content.
